(19) United States
(12) Patent Application Publication
(10) Pub. No.: US 2022/0290719 A1
(43) Pub. Date: Sep. 15, 2022

(54) PLAIN SHAFT BEARING

(71) Applicant: Flender GmbH, 46395 Bocholt (DE)

(72) Inventor: THOMAS MEYER, Stolberg (DE)

(73) Assignee: Flender GmbH, 46395 Bocholt (DE)

(21) Appl. No.: 17/635,973

(22) PCT Filed: Sep. 4, 2020
(86) PCT No.: PCT/EP2020/074739

§ 371 Date: Feb. 16, 2022

(30) Foreign Application Priority Data
Sep. 27, 2019 (EP) 19200173.3

(51) Int. Cl. F16C 33/14; F16C 17/02; B24C 1/04; F16C 17/10

(52) U.S. Cl. CPC F16C 33/14; F16C 17/02; B24C 1/04; F16C 17/102; F16C 2223/08; F16C 2360/31

(57) ABSTRACT

A plain shaft bearing, in particular of a shaft of a wind turbine gearbox, includes a sliding surface having a surface roughness. The sliding surface is further provided with a structure formed from depressions defined by a depth which is greater than the surface roughness and less than 80 μm.

The invention relates to a plain shaft bearing, in particular of a shaft of a wind turbine gearbox, with at least one sliding surface which has a surface roughness. The invention moreover relates to a method for producing such a plain shaft bearing. The invention relates in addition to a gearbox with at least one such plain shaft bearing, to a drive train with such a gearbox, to a wind turbine with such a drive train, and to an industrial application with such a gearbox.

The rotational speeds in a wind turbine gearbox depend on the tip speed ratio and lie in a range between six and twenty revolutions per minute. The generator speed lies in the range between 900 and 2000 revolutions per minute such that the gearbox has a key function, and a high efficiency rate of, for example, 98% (avoiding a high cooling effort) is obligatory for success in the market. Accordingly, any apparently small improvement to plain shaft bearing technology which plays a critical role for the gearbox, and to the efficiency rate, is a significant step.

Plain shaft bearings are subject to high stresses in gearboxes for wind turbines. Undesired mixed friction operation cannot be excluded, in particular in the case of dynamic peak loads or in the event of the individual mounting of blades. Very high contact pressures occur here with very low sliding speeds. Against this background, it must be assumed that there is no hydrodynamic load carrying capacity. Only the so-called microhydrodynamics inside the surface roughness of the sliding surfaces of the plain shaft bearing can contribute to the lubrication. These microhydrodynamics are, however, severely restricted because smoothing of the surface roughness of the plain shaft bearing sliding surfaces takes place during the running-in of a plain shaft bearing, as a result of which the microhydrodynamics are negligible, for example, when the individual blades are subsequently mounted.

In order to overcome this problem, it is known to provide the sliding surfaces of plain shaft bearings with a running-in or emergency running coating. Plain shaft bearings of this type are also referred to as multilayer plain shaft bearings. However, producing such a multilayer plain shaft bearing is very complex and expensive.

It is already known from the prior art:

DE 10 2014 208419 A relates to a running surface of a cam of a valve camshaft,

EP 1 207 314 A2 relates to a translational sliding bearing in a combustion engine between the piston and the cylinder.

DE 43 16 012 A1 relates to a method for the precision-machining of workpiece surfaces, in particular for the bores in the cylinder of a combustion engine.

EP2 341 248 A2 relates to a roller bearing, wherein individual rollers of the roller bearing are provided with a surface structure.

US 2009/139799 A1 concerns microstructures on gear wheels.

An object of the present invention is to provide a plain shaft bearing with an alternative structure which completely or at least partly overcomes the abovedescribed problem.

In order to achieve this object, the present invention provides a plain shaft bearing of the type mentioned at the beginning in which the sliding surface is provided with a structure formed from depressions, wherein the depth of the depressions is greater than the surface roughness and less than 80 μm and in particular lies within the range between 20-50 μm. The structure which is formed from depressions and provided in addition to the surface roughness inherent to the sliding surface supplies the microhydrodynamics of the corresponding sliding surface because the abovedescribed smoothing effect is compensated by the depressions, the depth of which is greater than the surface roughness of the sliding surface, as a result of which they are not smoothed or only slightly and hence are still present after running in.

The depressions are preferably arranged so that they are evenly distributed over the sliding surface in order to impart microhydrodynamics which are as uniform as possible to the whole sliding surface.

According to an embodiment of the present invention, depressions can take the form of grooves, wherein depressions which take the form of grooves advantageously extend transversely to the sliding direction, which entails particularly good efficiency.

Alternatively or additionally, depressions can take the form of bowls and/or troughs.

Depressions which take the form of bowls and/or troughs essentially have a square shape, for example with dimensions of 20×20×20 μm to 50×50×50 μm. In this connection, “essentially” means that the corners of the square shape can be rounded. The side faces can likewise be inclined.

According to an embodiment of the present invention, the orientation of depressions which take the form of bowls and/or troughs is non-uniform. Depressions which take the form of bowls and/or troughs with a non-uniform orientation can be produced simply and cost-effectively, for example by means of shot blasting, such that there is no need for expensive roller burnishing tools with dies.

The depressions which take the form of bowls and/or troughs preferably have an outer circumference within the range of 70-300 μm. Such dimensions have proved to be very effective.

The depressions advantageously have a surface percentage of 3-50% of the whole sliding surface, in particular a surface percentage of 30-50%. Effective microhydrodynamics are ensured with such a surface percentage.

In order to achieve the object mentioned at the beginning, the present invention moreover provides a method for producing a plain shaft bearing according to the invention, in which the depressions are produced by means of roller embossing, laser machining, sand blasting, shot blasting, and/or erosion. By means of these production methods, the depressions can be introduced into the at least one sliding surface of a plain shaft bearing with little effort and inexpensively.

The present invention moreover provides a gearbox with at least one plain shaft bearing according to the invention, in particular in the form of a planetary gear, in which, for example, the planetary gear wheels are mounted on their associated planetary gear wheel shaft and/or on the associated planetary gear wheel carrier with the use of plain shaft bearings according to the invention.

In addition, the present invention proposes a drive train comprising a rotor shaft which is connected, so as to transmit torque, to a gearbox which in turn is connected, so as to transmit torque, to a generator, wherein the gearbox is designed according to the invention.

The present invention furthermore provides a wind turbine comprising a rotor which is attached to a nacelle, wherein a drive train is arranged on the nacelle and is connected to the rotor so as to transmit torque, wherein the drive train is designed according to the invention. A rotor shaft of the drive train is here in particular mounted with the at least one plain shaft bearing.

The present invention furthermore provides an industrial application comprising a drive means which is connected, so as to transmit torque, to a gearbox which is coupled, so as to transmit torque, to a mechanical application, wherein the gearbox is designed according to the invention.

With regard to further advantageous embodiments of the invention, reference is made to the dependent claims and to the description below with the aid of the drawings, in which:

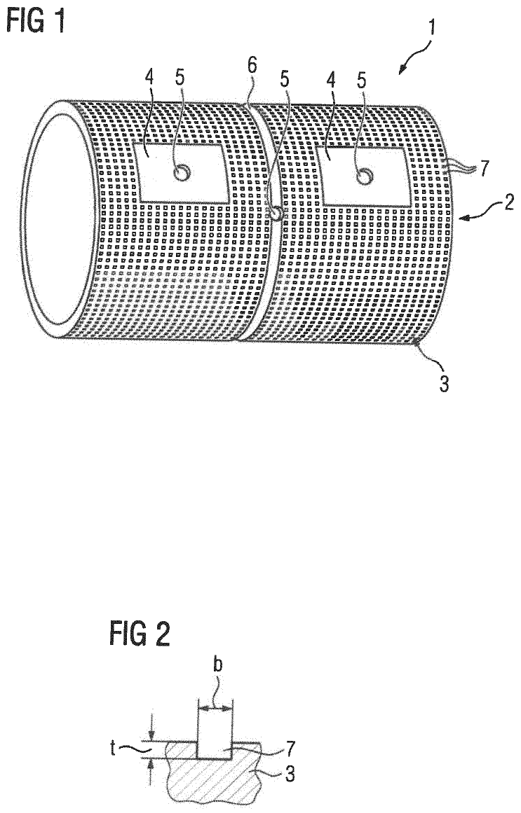

FIG. 1 shows a schematic perspective view of a radially acting plain shaft bearing or radial sliding bearing according to an embodiment of the present invention;

FIG. 2 shows an enlarged view in section of a depression which is formed on the sliding surface of the plain shaft bearing shown in FIG. 1;

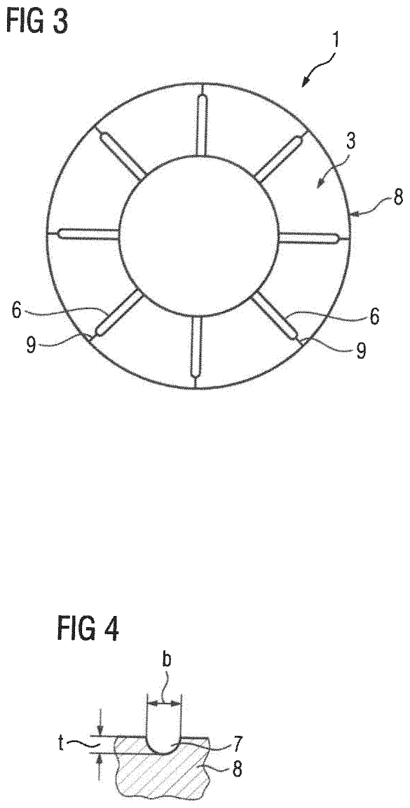

FIG. 3 shows a schematic side view of an axially acting plain shaft bearing or thrust bearing according to an embodiment of the present invention;

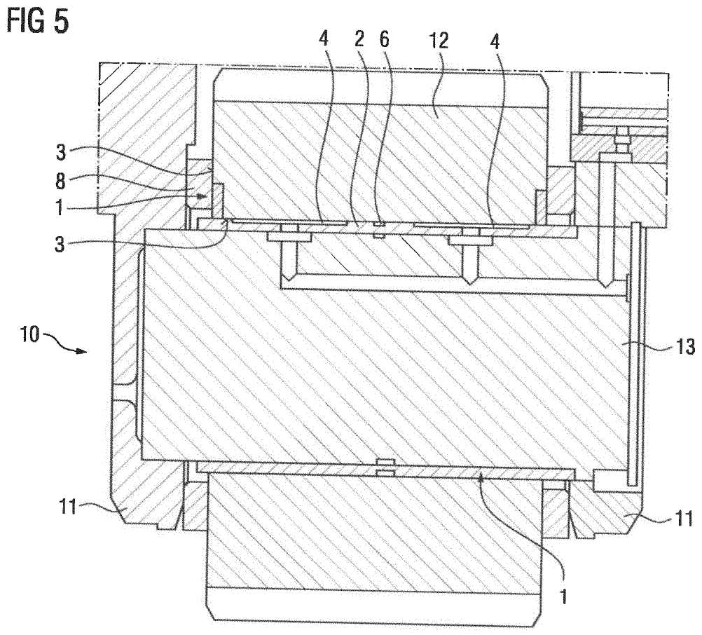

FIG. 4 shows an enlarged view in section of a depression which is formed on the sliding surface of the plain shaft bearing shown in FIG. 3;

FIG. 5 shows a view in section of a partial region of an embodiment of a gearbox according to the invention;

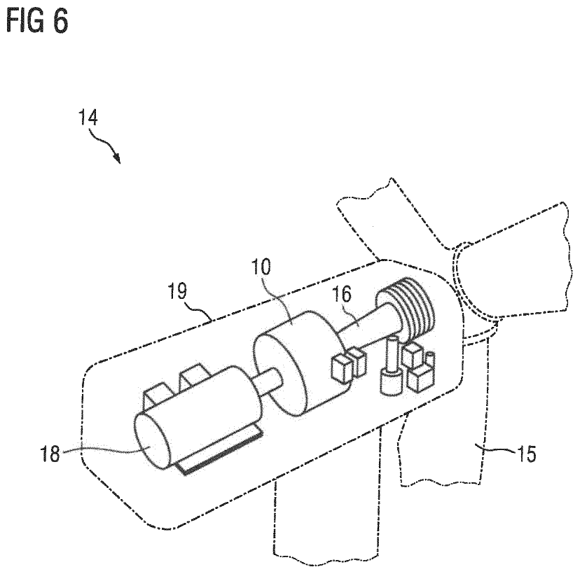

FIG. 6 shows a schematic view in section of an embodiment of a wind turbine according to the invention;

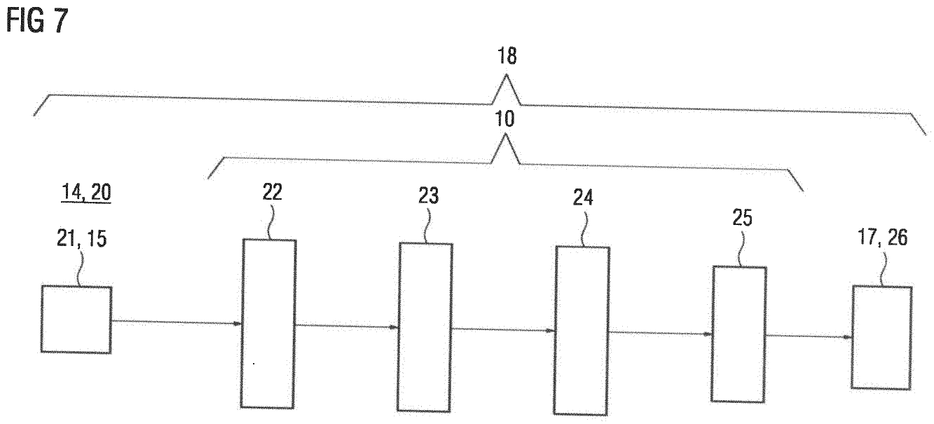

FIG. 7 shows a schematic view of an embodiment of a drive train according to the invention; and

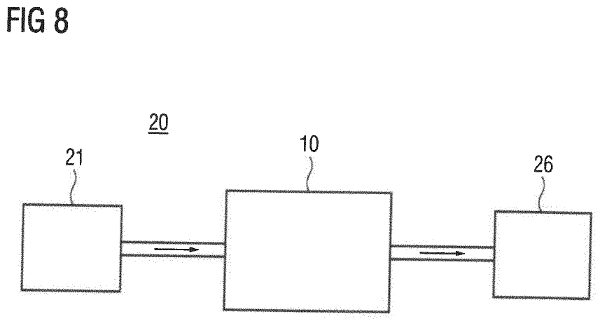

FIG. 8 shows a schematic view of an embodiment of an industrial application according to the invention.

The same reference symbols refer below to the same or similar components or component areas.

FIG. 1 shows a plain shaft bearing 1 according to an embodiment of the present invention, in which it is a radial sliding bearing. The plain shaft bearing 1 comprises a sleeve 2 which is produced from a plain shaft bearing material and in the present case a sliding surface 3 is defined on its outside. The sliding surface 3 has a predetermined surface roughness which is 10 μm in the present case. The inside of the sleeve 2 serves as a mounting surface for the force-fitting, form-fitting, or materially bonded fastening of the sleeve 2 to a component such as, for example, to a planetary gear wheel shaft of a gearbox, as explained in more detail below with reference to FIG. 5. It should, however, be clear that the sliding surface 3 can alternatively also be provided on the inside and the mounting surface on the outside of the sleeve 2. In the present case, two lubricant collecting recesses 4, which in the mounted state of the plain shaft bearing 1 are connected to a lubricant feed system via a bore 5, are formed on the sliding surface 3. A lubricant supply groove 6, which in the mounted state of the plain shaft bearing 1 is likewise connected to a lubricant feed system via a bore 5, moreover extends between the two lubricant collecting recesses 4. The sliding surface 3 is additionally provided with a structure which in the present case is formed by a plurality of depressions 7. The depth t of the respective depressions 7 starting from the outside of the sliding surface 3 is here greater than the surface roughness of the sliding surface 3 and less than 80 μm. In the present case, the depressions 7 have an essentially square shape with dimensions of 40×40×40 μm. FIG. 2 shows a view in cross-section of such a depression 7. It should, however, be clear that other shapes and dimensions can also be chosen, such as bowl-shaped depressions 7 with, for example, a circular cross-section, groove-shaped depression 7, or the like. The depth t should, however, not exceed 80 μm. The surface percentage of the depressions 7 on the whole sliding surface 3 is preferably between 3-50%, and in the present case is 40%.

FIG. 3 shows a plain shaft bearing 1 according to a further embodiment of the present invention, in which it is a thrust bearing. The plain shaft bearing 1 comprises an annular disk 8 which is produced from a plain shaft bearing material and defines a sliding surface 3 on one side. The sliding surface 3 has a predetermined surface roughness which is likewise 10 μm in the present case. The opposite side forms a mounting surface for the farce-fitting, form-fitting, or materially bonded fastening of the annular disk 8 to a component such as, for example, to a planetary gear wheel carrier cheek of a gearbox, as explained in more detail below with reference to FIG. 5. In the present case, a plurality of lubricant collecting grooves 4 which extend radially in a star shape are provided on the sliding surface 3 and in the present case are open at the radially inwardly situated end. At the radially outwardly situated end, the lubricant collecting grooves 4 are continued by narrower dirt grooves 9 which lead as far as the outer edge of the annular disk 8. The sliding surface 3 is provided, in a similar fashion to the first embodiment, with a structure which is formed in the present case by a plurality of depressions 7. The depth t of the respective depressions 7, starting from the outside of the sliding surface 3, is here greater than the surface roughness of the sliding surface 3 and less than 80 μm. In the present case, the depressions 7 take the form of grooves and have a U-shaped cross-section. The width b and depth h are each 50 μm. A view in cross-section of a depression 7 is shown in FIG. 4. It should, however, be clear that here too other shapes and dimensions can be chosen for the depressions 7. The depth t should, however, not exceed 80 μm. The surface percentage of the depressions 7 on the whole sliding surface 3 is preferably between 3-50%, and in the present case is 30%.

An essential advantage of the plain shaft bearing 1 illustrated in FIGS. 1 and 3 consists in the fact that the structure which is formed from depressions 7 and provided in addition to the surface roughness inherent to the sliding surface 3 largely supplies the microhydrodynamics of the corresponding sliding surface 3 because a smoothing effect which occurs when running in the corresponding plain shaft bearing 1 and minimizes the surface roughness of the sliding surface 3 is compensated by the depressions 7, the depth t of which is greater than the surface roughness of the sliding surface 3, as a result of which they are not or only slightly smoothed so that they are still present even after running in and contribute to the microhydrodynamics.

The depressions 7 of the plain shaft bearing 1 illustrated in FIGS. 1 and 3 are preferably produced by roller embossing, laser machining, sand blasting, shot blasting, and/or erosion, as a result of which the plain shaft bearing 1 can be produced simply and inexpensively.

FIG. 5 shows a partial region of a gearbox 10 according to an embodiment of the present invention, in which it is a planetary gear. To be more precise, FIG. 5 shows a planetary gear wheel 12, mounted rotatably on a planetary gear wheel carrier 11, with an associated planetary gear wheel shaft 13. The planetary gear wheel 12 is mounted radially using a plain shaft bearing 1 shown in FIG. 1 which is fastened by the inside of its sleeve 2 to the planetary gear wheel shaft 13. For axial mounting, two plain shaft bearings 1 as illustrated in FIG. 3 are used, fixed to the planetary gear wheel carrier 11.

An embodiment of a wind turbine 14 according to the invention is illustrated in FIG. 6. The wind turbine 14 comprises a rotor 15 which can be set in rotation by the wind. The rotor 15 is connected, so as to transmit torque, to a gearbox 10 according to the invention via a rotor shaft 16. The gearbox 10 in turn is connected to a generator 17 so as to transmit torque. The rotor shaft 16, the gearbox 10, and the generator 17 are part of a drive train 18 which is housed in a nacelle 19 of the wind turbine 14. The generator 17 has two, three, or four pole pairs.

FIG. 7 shows a schematic structure of an embodiment of a drive train 18 according to the invention which can be employed in a wind turbine 14 (not illustrated in detail) or in an industrial application 20 (not illustrated in detail). The drive train 18 comprises a gearbox 10 according to the invention which is connected on the input side to a drive means 21 or a rotor 15 of the wind turbine 14 and to which drive power is thus fed. This takes place in a wind turbine 14 by means of a rotor shaft 16. The gearbox 10 comprises in the present case planetary stages 22, 23, and 24 and a spur gear stage 25, which are arranged one behind the other. The gearbox stages 22, 23, 24, and 25 deliver output power to a generator 17 or a mechanical application 26.

The structure of an embodiment of an industrial application 20 according to the invention which has a drive means 21 is illustrated schematically in FIG. 8. The drive means 21 is designed to supply a drive power which is transported to a gearbox 10 according to the invention by a connection which transmits torque. The gearbox 10 is in turn connected, so as to transmit torque, to a mechanical application 26 in order to transport output power to the mechanical application 26.

Although the invention has been illustrated and described in detail by the preferred exemplary embodiment, the invention is not restricted by the disclosed examples and other variations can be derived by a person skilled in the art without going beyond the protective scope of the invention.

1.-14. (canceled)

15. A plain shaft bearing, in particular of a shaft of a wind turbine gearbox, said plain shaft bearing comprising a sliding surface having a surface roughness, said sliding surface provided with a structure formed from depressions defined by a depth which is greater than the surface roughness and less than 80 μm.

16. The plain shaft bearing of claim 15, wherein the depth of the depressions lies within a range between 20-50 μm.

17. The plain shaft bearing of claim 15, wherein the depressions are evenly distributed over the sliding surface.

18. The plain shaft bearing of claim 15, wherein at least one of the depressions has a groove-shaped configuration.

19. The plain shaft bearing of claim 18, wherein the at least one of the groove-shaped depressions extends transversely to a sliding direction.

20. The plain shaft bearing of claim 15, wherein at least one of the depressions has a bowl-shaped or trough-shaped configuration.

21. The plain shaft bearing of claim 20, wherein the at least one of the bowl-shaped or trough-shaped depressions has an essentially square shape.

22. The plain shaft bearing of claim 20, wherein the at least one of the bowl-shaped or trough-shaped depressions has an orientation which is non-uniform.

23. The plain shaft bearing of claim 20, wherein the at least one of the bowl-shaped or trough-shaped depressions has an outer circumference within a range of 70-300 μm.

24. The plain shaft bearing of claim 15, wherein the depressions have a surface percentage of 3-50% of the sliding surface as a whole.

25. The plain shaft bearing of claim 15, wherein the depressions have a surface percentage of 30-50% of the sliding surface as a whole.

26. A method for producing a plain shaft bearing, comprising:
roughening a sliding surface to provide a surface roughness; and
treating the sliding, surface with a process selected from the group consisting of roller embossing, laser machining, sand blasting, shot blasting, erosion, and any combination thereof, to provide a structure formed from depressions which are defined by a depth which is greater than the surface roughness and less than 80 μm.

27. The method of claim 26, wherein the depressions are evenly distributed over the sliding surface.

28. The method of claim 26, wherein at least one of the depressions has a bowl-shaped or trough-shaped configuration of essentially square shape.

29. The method of claim 26, wherein the depressions have a surface percentage of 3-50% of the sliding surface as a whole.

30. A gearbox, comprising a plain shaft bearing, said plain shaft bearing comprising a sliding surface having a surface roughness, said sliding surface provided with a structure formed from depressions defined by a depth which is greater than the surface roughness and less than 80 μm.

31. A drive train, comprising:
a gearbox as set forth in claim 30;
a rotor shaft connected to the gearbox so as to transmit torque to the gearbox; and
a generator connected to the gearbox such that the gearbox transmits the torque to the generator.

32. A wind turbine, comprising:
a nacelle;
a rotor attached to the nacelle; and
a drive train arranged on the nacelle and connected to the rotor so as to transmit torque, said drive train including a gearbox as set forth in claim 30, a rotor shaft connected to the gearbox so as to transmit torque to the gearbox, and a generator connected to the gearbox such that the gearbox transmits the torque to the generator.

33. The wind turbine of claim 32, wherein the rotor shaft of the drive train is mounted with the plain shaft bearing of the gear box.

34. An industrial application, comprising:
a gearbox as set forth in claim 30 and coupled to a mechanical application so as to transmit torque to the mechanical application; and
a drive connected to the gearbox so as to transmit torque to the gearbox.
